(19) United States
(12) Patent Application Publication
(10) Pub. No.: US 2014/0192207 A1
(43) Pub. Date: Jul. 10, 2014

(54) METHOD AND APPARATUS TO MEASURE VIDEO CHARACTERISTICS LOCALLY OR REMOTELY

(71) Applicants: Jinsong Ji, Shanghai (CN); William Herz, Sunnyvale, CA (US)

(72) Inventors: Jinsong Ji, Shanghai (CN); William Herz, Sunnyvale, CA (US)

(21) Appl. No.: 14/147,803

(22) Filed: Jan. 6, 2014

Related U.S. Application Data
(60) Provisional application No. 61/749,635, filed on Jan. 7, 2013.

(51) Int. Cl. H04N 17/04

(52) U.S. Cl. CPC H04N 17/04
USPC 348/184

(57) ABSTRACT

A system for displaying video is provided that includes a first computing system that has a first display and is operable to render video data from a multimedia source. A video measurement module is associated with the first computing device and operable to calculate from the video data at least one statistic representing at least one aspect of the video data and generating for display a visual depiction of at least one statistic to a user.

This application claims benefit under 35 USC 119(e) of prior provisional application Ser. 61/749,635, filed Jan. 7, 2013.

### BACKGROUND OF THE INVENTION

1. Field of the Invention

This invention relates generally to computing systems and software, and more particularly to systems capable of playing media and methods of using the same.

2. Description of the Related Art

With the advent of affordable video equipment, video editing software and online video streaming, current consumers of video products have a large collection of media sources to choose from. These various video sources are not necessarily uniform in quality. Many sources can have unwanted artifacts that affect the user experience. In these circumstances, extra video playback settings are required for the user to obtain a better video experience. Without a good reference, a typical user might normally attempt to adjust the settings multiple times just to evaluate the picture quality, and still end up with an unsatisfactory result.

For an amateur to capture video with a web camera or a digital video camera, the video quality may be sub-par due to a variety of factors, such as poor environment and/or poor capture skills. This type of video might benefit from a good measurement tool in order to find defects associated with luminance, chrominance and some other factors. A traditional method to measure video luminance, chrominance and color is to send the video signal to special oscilloscopes (Waveform Monitor or Vectorscope). These devices tend to be expensive and difficult to use, sometimes even for experienced users.

Traditional broadcast video has somewhat predictable encoding, and thus luminance and chrominance that falls within certain ranges. However, video produced and viewed on a personal computer can have much wider ranges of luminance and chrominance. Here, desired adjustments may be much more numerous.

The present invention is directed to overcoming or reducing the effects of one or more of the foregoing disadvantages.

### SUMMARY OF EMBODIMENTS OF THE INVENTION

In accordance with one aspect of an embodiment of the present invention, a system for displaying video is provided that includes a first computing system that has a first display and is operable to render video data from a multimedia source. A video measurement module is associated with the first computing device and operable to calculate from the video data at least one statistic representing at least one aspect of the video data and generate for display a visual depiction of at least one statistic to a user.

In accordance with another aspect of an embodiment of the present invention, a method includes providing a first computing system that has a first display and is operable to render video data from a multimedia source. From the video data at least one statistic is calculated that represents at least one aspect of the video data. A visual depiction of at least one statistic is presented to a user.

In accordance with another aspect of an embodiment of the present invention, in a system that includes a first computing system with a first display and operable to render video data from a multimedia source, a method is provided that includes calculating from the video data at least one statistic representing at least one aspect of the video data, and presenting a visual depiction of at least one statistic to a user.

In accordance with another aspect of an embodiment of the present invention, a computer readable medium that has computer readable instructions for performing a method that includes rendering video data from a multimedia source, calculating from the video data at least one statistic representing at least one aspect of the video data, and presenting a visual depiction of at least one statistic to a user.

### BRIEF DESCRIPTION OF THE DRAWINGS

The foregoing and other advantages of the invention will become apparent upon reading the following detailed description and upon reference to the drawings in which:

FIG. 1 is a schematic representation of an embodiment of a computing system that is operable to generate video measurement information and present that information to a user;

FIG. 2 is a schematic representation of an embodiment of a computing system;

FIG. 3 is another schematic representation of a few exemplary types of computing systems;

FIG. 4 is a schematic depiction of some exemplary types of media sources usable with computing systems;

FIG. 5 is a schematic depiction of a conventional video playback pipeline;

FIG. 6 is a schematic depiction of an exemplary embodiment of video playback pipeline incorporating a video measurement module;

FIG. 7 is a schematic depiction of an alternate exemplary embodiment of video playback pipeline incorporating a video measurement module;

FIG. 8 is a schematic depiction of an exemplary embodiment of a video measurement module;

FIG. 9 is an exemplary video frame;

FIG. 10 is the exemplary video frame of FIG. 9 but with a pixel array overlaid thereon;

FIG. 11 is an exemplary embodiment of a luminance statistic bitmap;

FIG. 12 is schematic depiction of a portion of the luminance statistic bitmap of FIG. 11;

FIG. 13 is an exemplary embodiment of a chrominance statistic bitmap;

FIG. 14 is a schematic depiction of a portion of the chrominance statistic bitmap of FIG. 13;

FIG. 15 is an exemplary embodiment of a luminance histogram statistic bitmap;

FIG. 16 is an exemplary embodiment of a R component histogram statistic bitmap;

FIG. 17 is an exemplary embodiment of a G component histogram statistic bitmap;

FIG. 18 is an exemplary embodiment of a B component histogram statistic bitmap;

FIG. 19 is a schematic depiction of an exemplary embodiment of video measurement adjustments interface; and

FIG. 20 is a schematic depiction of a few exemplary processors that may be used in parallel and/or serial for data processing.

### DETAILED DESCRIPTION OF SPECIFIC EMBODIMENTS

Various embodiments of computing systems operable to display video deliver to a user information about the video data used to render the video are disclosed. One variation includes a computing system that has a video measurement module inserted into the video playback pipeline. The video measurement module is capable of making various measurements of video characteristics, such as luminance, chrominance and color data, and generating one or more statistics based on the measurements and presenting the statistic(s) to a user in visual form. The visual representation may be on the computing systems display or the display of another computing system linked to original computing system. Control and video settings may flow between the linked computing systems. Additional details will now be described.

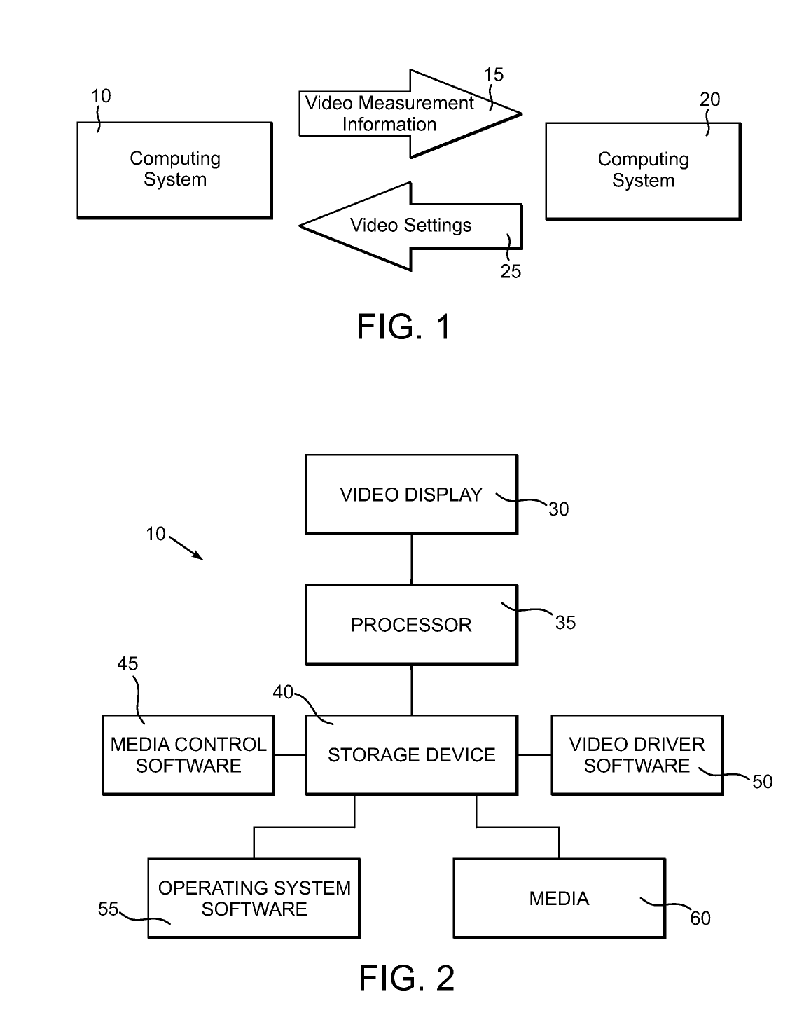

In the drawings described below, reference numerals are generally repeated where identical elements appear in more than one figure. Turning now to the drawings, and in particular to FIG. 1, therein is shown a schematic representation of an embodiment of a computing system 10 that is operable to generate video measurement information 15 that may be presented to a user in one form or another to enable the user to quickly identify certain characteristics of a video display of the computing system 10. The video measurement information 15 may be optionally transmitted to another computing system 20. The same or another user of the computing system 20 may be provided with visual cues based on the video measurement information 15 from the computing system 10. Based on those cues, the user of the computer system 20 may transmit video settings 25 back to the computing system 10. The transmission of the video measurement information 15 and the video settings 25 may be by wired connection, wireless connection or some combination of the two.

There are many possible types of video settings 25 that may be transmitted from the computing system 20 to the computing system 10. A non-exhaustive list of the types of video settings 25 includes stabilization, motion compensated frame rate conversion, super resolution (scaling), noise reduction, contour reduction, detail enhancement, color enhancement, standard color adjustments, flesh tone enhancement, video gamma, deinterlacing, pulldown or cadence correction, edge enhancement, denoise, split screen modes, enforce smooth video playback, mosquito noise reduction, deblocking, brighter whites, red, green, blue stretch, dynamic contrast enhancement, color range and color space, video pop, deblurring and 2D to 3D conversion. In addition, the computing system 20 can send back other settings that control other than video characteristics. Examples include entering/exiting full screen mode, system shutdown or others.

The computer systems 10 and 20 may take on a great variety of configurations and include various features. The following description of the computing system 10 will be illustrative of the computing system 20 as well. In this illustrative embodiment, the computer system 10 is represented schematically in FIG. 2 and may include some type of video display 30, a processor 35, at least one storage device 40, media control software 45, optional video driver software 50, operating system software 55 and some form of media 60. It should be understood that the computing system 20 may be similarly configured. The video display 30 may take on a great variety of configurations, such as a monitor, an integrated video screen in a computer, handheld device or other device, a television, or the like. The processor 35 may be an integrated circuit dedicated to video processing, a central processing unit (CPU), graphics processing unit (GPU), an accelerated processing unit (APU) that combines microprocessor and graphics processor functions, an application specific integrated circuit or other device. An exemplary APU may include fixed function cores for compression, decompression, pre-imposed or post-imposed processing tasks or others. Indeed, the processor 35 may consist of multiple examples of such integrated circuits operating in parallel or otherwise.

The storage device 40 is a computer readable medium and may be any kind of hard disk, optical storage disk, solid state storage device, ROM, RAM or virtually any other system for storing computer readable media. The media control software 45 that is designed to enable the user to manipulate various aspects of video playback and other features. The media control software 45 may take on a variety of forms. One exemplary embodiment may be an application presently known as Video Power Pack (VPP) available from Advanced Micro Devices, Inc. Other examples include video preprocessing for transcoding or encoding for wireless displays, video conferencing or others. The optional video driver software 50 may be used depending upon the capabilities of the operating system software 40 and the overall capabilities of the processor 35. The media control software 45 is intended to be platform and operating system neutral. Thus, the operating system software 55 may be virtually any type of software design to facilitate the operation of the processor 25 and a storage device 30. Windows®, Linux, iOS or more application specific types of operating system software may be used or the like. The types of media 60 will be described in conjunction with a subsequent figure. It should be understood that the media control software 45, the optional video driver software 50 and the operating system 55 may be resident on the storage device 40 or stored in some other location and transferred to the computing system 10 as necessary by way of some form of network connection or other type of delivery system.

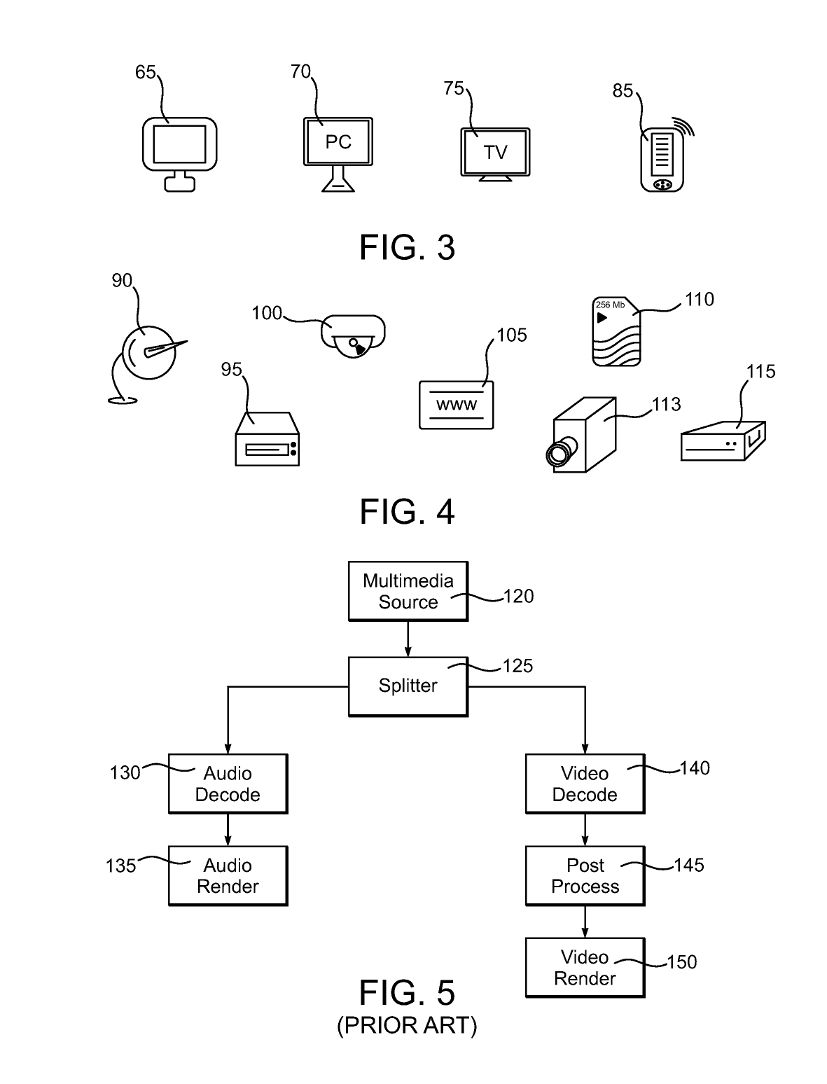

FIG. 3 is a schematic representation of a few exemplary types of computer systems 10 and 20 capable of displaying video. For example, a video monitor 70, a personal computer 75, a television 80 or a mobile computing device like a handheld device 85 (e.g., a smart phone), other personal digital assistant or even a remote control with a display, may be used. The external monitor 70 may be connected to some other type of video delivery system, such as an optical disk player, a computer, a set top box or the like. The same is true for the personal computer 70 and the TV 75. It should be understood that various levels of integration may be implemented to combine features. For example, the TV 75 may include an integrated optical disk player, hard drive or the like and even incorporate the media control software 45 and operating system software 55. In another example, the smart phone 85 may integrate all the features of FIG. 2 in a single enclosure. A computer system 10 could be embodied as a conventional desktop, notebook or server computer system, mobile (e.g., handheld or palm/pad type) computer system, intelligent television, set top box, computer kiosk or any other computing platform. Thus, the terms “computer system” as used herein contemplates various levels of device integration as well as embedded systems, x86-based, or other architecture.

FIG. 4 depicts schematically some of the types of media sources anticipated that may be used with the computing systems 10 and 20 depicted in FIG. 1. Examples include media supplied by satellite tuner 90, cable set top box 95, optical disk player 100, internet streaming 105, a removable storage device 110, a live source such as a camera or web camera 113, or a hard drive 115. These represent just a few examples of the types of media that may be used to deliver video signals to the video processor and thus the video display depicted in FIG. 2.

A conventional multimedia processing pipeline may be understood by referring now to FIG. 5, which is a schematic representation. A multimedia source 120, which may be an optical disk, a file on a hard drive, streamed IP packets or any of the types of media described above provides a signal to a splitter 125, which is operable to divide the source signal into an audio and a video feed. The audio feed is delivered to an audio decode 130 and thereafter to an audio render stage 135. The video side of the signal is delivered to a video decode stage 140, then onto a post process stage 145 and finally to a video render stage 150. The information passed from the post process stage 110 to the video render 150 will typically involve a sequence of video frames.

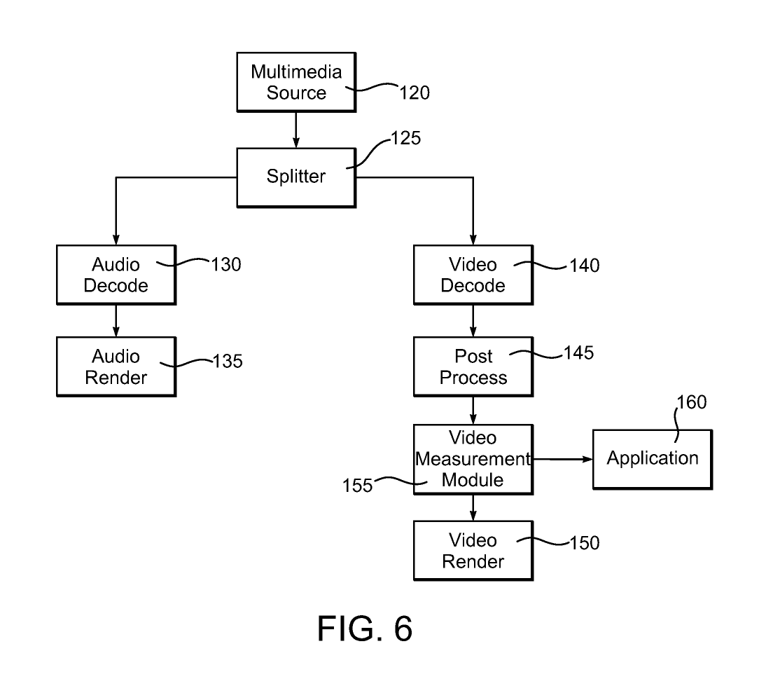

A new multimedia processing pipeline in accordance with an embodiment may be understood by referring now to FIG. 6, which is a schematic representation, and again to FIG. 1. Here, the multimedia source 120, the signal splitter 125, the audio decode and audio render stages 130 and 135 as well as the video decode 140 and the post process 145 may be configured as described above in conjunction with the conventional design shown in FIG. 5. However, this illustrative embodiment is provided with a video measure stage or module 155 that is operable to make measurements of various video characteristics and deliver those measurements in the form of video measurement information 15 (see FIG. 1) to the video render stage 150 for visual presentation to the user or to a separate application 160, like a media player program for example, again for visual presentation to the user. In any of the disclosed embodiments, the application 160 may be running on the computing system 10 or on the remote computing system 20 shown in FIG. 1. Playback frames may also be included with the video measurement information to enable the user to view both content and information from the computing system 10 on the computing system 20.

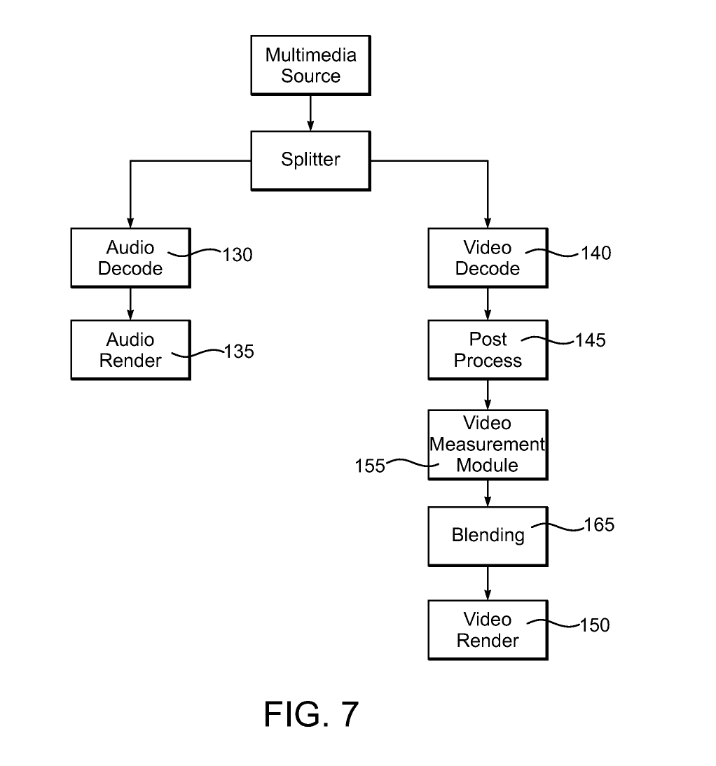

In an alternate exemplary embodiment, represented schematically in FIG. 7, the multimedia processing pipeline may again utilize the multimedia source 120, the splitter 125, the audio decode stage 130, the audio render 135, the video decode 140, the post processing 145 and the video measure module 155 just described in conjunction with FIG. 6. In the embodiment depicted in FIG. 6, the output of the video measure 155 is delivered to a separate application 160. However, in this illustrative embodiment, the output of the video measure 155 may be delivered to a blending stage 165, which then combines the video output of the post process stage 145 with the video measurement information 15 (see FIG. 1) and delivers that combined output to the video render stage 150. Thus, assume for purposes of illustration that the user is viewing a media file on a computer screen, in this circumstance, this blended display of the video and the video measurement information will be presented to the user on the same window or screen.

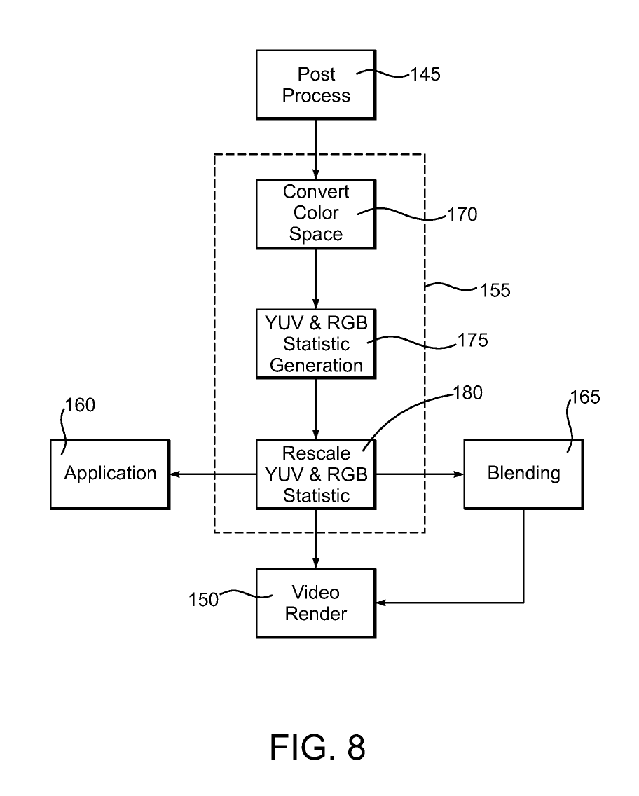

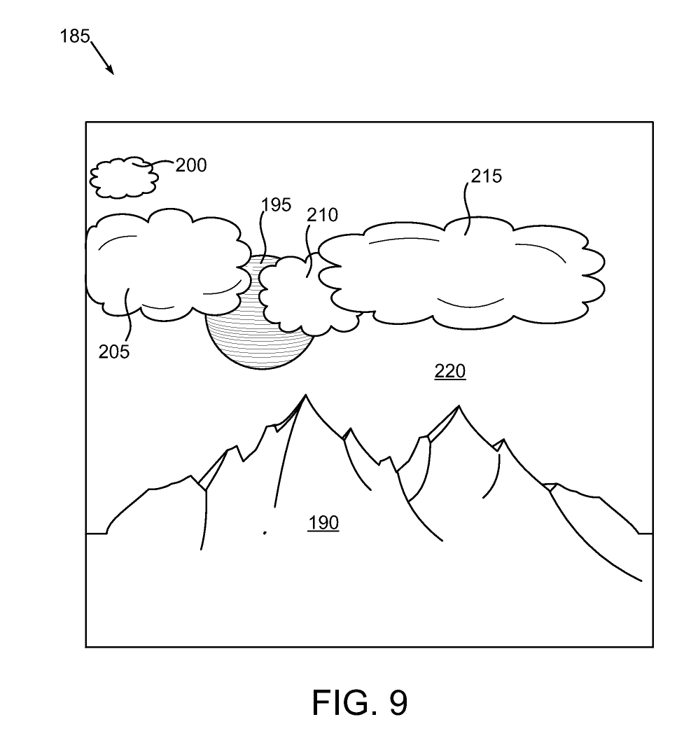

Additional details of an embodiment of the video measure module 155 may be understood by referring now to FIG. 8, which is a schematic representation. Here, the post process stage 145 delivers an input, in the form of frame data, to the video measure module 155 schematically represented by the dashed box. The video measure module 155 may be implemented as stand alone software, software plus hardware, as an add on to the media control software 45 shown in FIG. 2 or otherwise. The video measure module 155 may analyze the frame data to determine various video image characteristics. One or more image characteristics may be examined and, as described below, one more statistics may be presented visually to the user. In an exemplary embodiment, the measured characteristics may include luminance, chrominance and color information. The luminance component or “brightness” is simply the brightness of the panchromatic monochrome image that would be displayed by a black and white receiver, such as a television receiver, although detail and frequency component or spectral analysis can also be represented. The chrominance component is the color information of the video frame. The color information consists of the R, G and B components. To make these determinations, the video measure module 155 may include a convert color space stage 170, which delivers an input to a YUV and RGB statistic generation stage 175. The convert color space stage 170 converts a signal encoded in one scheme, for example RGB, to another color space such as YUV. These conversions are based on well-known principles and will not be discussed further. In this illustrative embodiment, frame data encoded in RGB is converted by the convert color space stage 170 to YUV and the data encoded in both RGB and YUV used to yield luminance, chrominance and color statistics by the YUV and RGB statistic generation stage 175, which will be described in more detail below in conjunction with FIGS. 9, 10, 11, 12, 13, 14, 15, 16 and 17. The YUV and RGB statistic generation stage 175 may optionally deliver an output to a rescale YUV and RGB statistic stage 180. The rescale YUV and RGB statistic stage 180 may be used in circumstances where the bandwidth budget associate with the output of the YUV and RGB statistic generation 175 is large enough to impact latency, user video quality and other characteristics, such as, but not limited to, continuity. A variety of different schemes may be used, such as, scaling, bilinear interpolation or others. The rescaling could be spatially-based or temporally-based. Regardless of whether the video measure module 155 includes the rescale YUV and RGB statistic stage 180, the output of the YUV and RGB statistic generation stage 175 may be delivered to a variety of locations. For example, the output may be delivered to the application 160 described above in conjunction with FIG. 6. Optionally, a blending action may be used such that the output is provided to the blending stage 165 described above in conjunction with FIG. 6 and from there to the video render stage 150. In another option, the output of the YUV and RGB statistic generation module 155 may be delivered directly to the video render stage 150 but without blending.

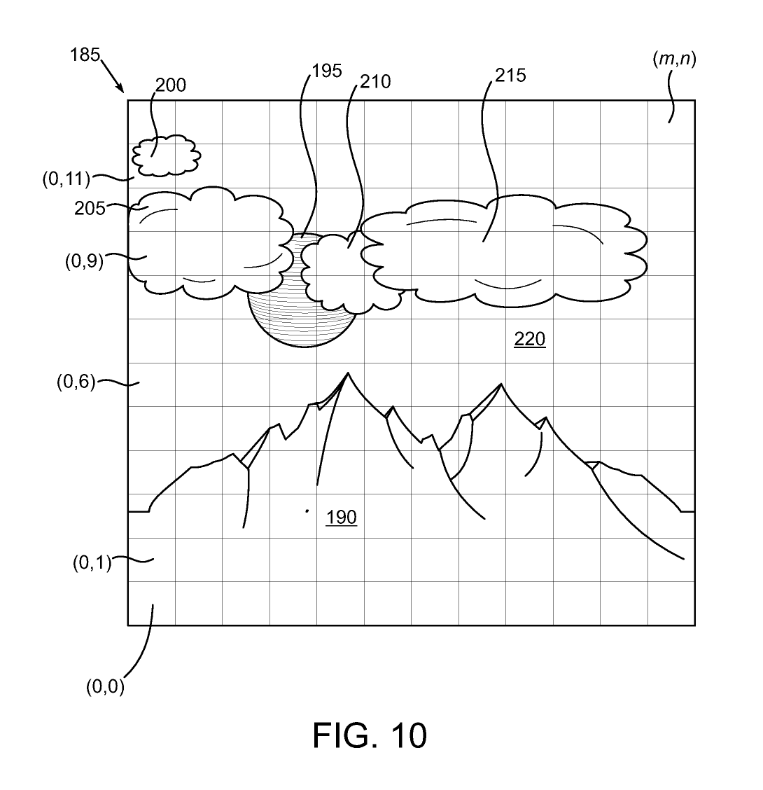

The operation of the YUV and RGB statistic generation stage 175 shown in FIG. 8 will be described now in conjunction with FIGS. 9, 10, 11, 12, 13, 14, 15, 16 and 17 and initially to FIGS. 9 and 10. FIGS. 9 and 10 depict a single video frame 185 of a relatively simplified nature scape that includes a dark mountain range 190, the sun 195 and a few white clouds 200, 205, 210 and 215 that are in front of an otherwise pale background 220. The video frame 185 is depicted in FIG. 9 without a pixel map for simplicity of illustration, but with pixels in FIG. 10. As shown in FIG. 10, the video frame 185 consists of an array of pixels (0,0) to (m, n) where m represents the video frame width and n represents the video frame height. In this simple illustration, the pixel array (0,0) to (m, n) numbers only one hundred and forty-four pixels. However, the skilled artisan will appreciate that video displays may include much larger numbers of pixels. The video measure module 155 is operable to obtain statistics from luminance, chrominance, red, green and blue data. Some hypothetical luminance data, illustrated in Table 1 below, is a two-dimensional array, not unlike the output of a waveform monitor, where the x-axis is the direction of the frame width and the y-axis is the range of luminance values (i.e., the “Y” of YUV data). The ellipses in Table 1 and the other tables herein are used in the ordinary sense to omit table entries for simplicity of depiction and description.

TABLE 1
Luminance Statistics Data

| | | | | |
|---|---|---|---|---|
| 255 | 0 | 1 | . . . | 1 |
| . | . | . | . . . | . |
| . | . | . | | . |
| . | . | . | | . |
| 243 | 4 | 0 | . . . | 1 |
| . | . | . | . . . | . |
| . | . | . | | . |
| . | . | . | | . |
| 101 | 1 | 2 | . . . | 2 |
| . | . | . | . . . | . |
| . | . | . | | . |
| . | . | . | | . |
| 21 | 2 | 0 | . . . | 1 |
| . | . | . | . . . | . |
| . | . | . | | . |
| . | . | . | | . |
| 1 | 2 | 3 | . . . | 0 |
| 0 | 0 | 0 | . . . | 1 |
| (Pixel Array Column, Y value) | 0 | 1 | . . . | m |

To obtain the data for Table 1, the luminance values for each of the pixels (0,0) to (m, n) are obtained by the video measure module 155. For example, and referring to FIG. 10, the pixel (0, 0) corresponding to a portion of the relatively dark mountain range 190 may have some luminance value of say 21 on a scale of 0 to 255. The pixel (0,1) may have the same luminance value of 21 while the pixel (0,6) may have a greater luminance value of say 101 and the pixel (0,9), which involves some portion of the cloud 205 may have a luminance value of 243. Similarly, the pixel (0,11) may have the same luminance value of 243. This vertical scan of pixel columns is generated across the entire video frame width m and for each column and the number of occurrences of each luminance value is tallied and those tallies are represented in Table 1. For this hypothetical data set, the first vertical scan (i.e., Column 1) yields 0 pixels with a luminance value of 0, 2 pixels with a luminance value of 1, 2 pixels with a luminance value of 21, 4 pixels that have a luminance value of 243, 0 pixels with a luminance of 255 and so on. This aggregation of the luminance values per vertical scan is replicated across the entire video width m.

Next, the chrominance statistic is generated using a different analysis of the pixel array (0,0) to (m, n) for the video frame 185 shown in FIG. 10. Table 2 below shows a hypothetical chrominance array, which is a two-dimensional array where the x-axis is the range of U values and the y-axis is the range of V values.

TABLE 2
Chrominance Statistics Data

| | | | | | |
|---|---|---|---|---|---|
| 127 | 0 | 1 | . . . | 1 | 1 |
| 126 | 3 | 0 | . . . | 2 | 1 |
| . | . | . | . . . | . | . |
| . | . | . | | . | . |
| . | . | . | | . | . |
| 104 | 1 | 2 | . . . | 0 | 3 |
| . | . | . | . . . | . | . |
| . | . | . | | . | . |
| . | . | . | | . | . |
| −127 | 2 | 0 | . . . | 1 | 1 |
| −128 | 2 | 0 | . . . | 1 | 1 |
| (U value, V value) | −128 | −127 | . . . | 126 | 127 |

In this illustration, the U and V values range from −128 to 127. The U and V values for each pixel are calculated and then examined to determine the repetitions of particular U and V values. For example, and still referring to FIG. 10, assume that pixel (0,0) has a UV value of −128, −128 and that the pixel (0,11) has a UV value of 126, −128. Table 2 shows that there are 2 pixels with U,V values of −128, −128, 2 pixels with U,V values of −128, −127, 3 pixels with U,V values of −128, 126 and so on.

Next, a luminance histogram statistic is generated using the scan of the pixel array (0,0) to (m, n) for the video frame 185 shown in FIG. 10. Table 3 below shows a hypothetical luminance histogram statistic, which is an array where the x-axis is the range of luminance and the y-axis is the counts representing the number of instances of particular luminance values for the entire frame 185.

TABLE 3
Luminance Histogram Statistics Data

| | | | | | |
|---|---|---|---|---|---|
| Counts | 1 | 9 | . . . | 13 | 23 |
| Y value | 0 | 1 | . . . | 254 | 255 |

Finally, R, G and B histograms statistics are generated using the scan of the pixel array (0,0) to (m, n) for the video frame 185 shown in FIG. 10. Tables 4, 5 and 6 below show hypothetical R, G and B histogram statistics, which are each arrays where the x-axis is the range of each color and the y-axis is the counts representing the number of instances of particular color values in the range of 0 to 255.

TABLE 4
R Histogram Statistics Data

| | | | | | |
|---|---|---|---|---|---|
| Counts | 1 | 4 | . . . | 7 | 43 |
| R value | 0 | 1 | . . . | 254 | 255 |

TABLE 5
G Histogram Statistics Data

| | | | | | |
|---|---|---|---|---|---|
| Counts | 3 | 11 | . . . | 19 | 5 |
| G value | 0 | 1 | . . . | 254 | 255 |

TABLE 6
B Histogram Statistics Data

| | | | | | |
|---|---|---|---|---|---|
| Counts | 23 | 3 | . . . | 13 | 2 |
| B value | 0 | 1 | . . . | 254 | 255 |

The statistics just described are further processed to generate final display data, in the form of bitmaps or otherwise, to be presented to the user. These bitmaps to be described below may constitute examples of the video measurement information 15 that may be generated for the user in the computing system 10 and delivered to the computing system 20 depicted in FIG. 1 and described above. The display to the user in an exemplary embodiment can be presented visually as one more bitmaps or other image formats. The x-axis of the luminance statistic is frame width may be much bigger than, for example 256, in most cases, so scaling down may be required, and perhaps performed by the Rescale YUV & RGB Statistic stage 180 shown in FIG. 8. The Rescale YUV & RGB Statistic stage 180 may be operable to enable the user, through a suitable interface, to redefine the final display width of the luminance statistic data (Table 1) because too much scaling may introduce more errors. As an option, a user can choose bilinear interpolation or sampling to scale down the luminance statistic data (of Table 1). As an example, Table 1 may be resample to yield a corresponding table with a x-axis size of m-x. For example, where m is larger than 256, the resampling might produce an x-axis with a width of 256.

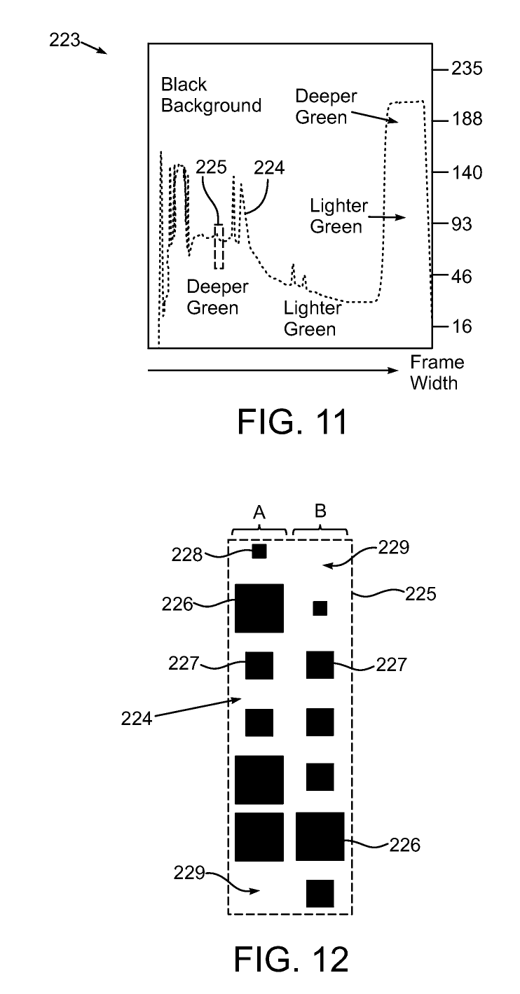

An exemplary final luminance display bitmap 223 that may be presented to the user is depicted schematically in FIG. 11. The luminance display bitmap 223 may consist of an array 224 of green pixels with a black background where the green pixels reflect luminance distribution. The usage of green in the bitmap 223 is optional and intended to emulate the green used in traditional oscilloscopes. Indeed, the colors used in any of the bitmaps disclosed herein are optional. The x-axis is in the direction of frame width and the y-axis is the range of luminance values, so luminance values (from Table 1) that occur more frequently in the frame 185 with be displayed with a darker green shades in the luminance display bitmap 225 and, conversely, those that occur with less frequency are shaded in lighter green. In Table 1 (0, 243) has the highest number of occurrences, which is 4, so the pixel (0, 243) on the display bitmap 223 is given the deepest value of green that is 255. The depth of green for the other pixels is given by:

depth of green=(counts)(255)/(maximum counts) (1)

The scale of FIG. 11 is such that individual pixels of the array 224 are difficult to readily depict. However, and to aid understanding, the differing green depths or intensities can represented graphically in black and white in FIG. 12. Before turning to FIG. 12, note that the small dashed rectangle encompasses a portion 225 of the pixel array 224 in FIG. 11. The portion 225 of the pixel array 224 is shown schematically and at greater magnification in FIG. 12. The portion 225 includes respective segments of vertical scan A and vertical scan B, where A and B are simply some adjacent x-axis positions on the bitmap 223 shown FIG. 11. FIG. 12 represents pixels from FIG. 11 with different green intensities graphically in the form of black squares of different sizes. The large black squares 226 represent pixels with high intensity green color, the medium size squares 227 represent pixels with medium intensity green, the small black squares 228 represent pixels with low intensity green and the blank(s) 229 represent pixels with zero intensity (i.e. the background color, such as the black background in FIG. 11). Of course, there may be more or less size categories. Note than scan B exhibits a slightly different distribution of green intensity values, again represented graphically by the black squares 226, 227 and 228 and the blank 229.

Referring again to FIG. 11, it may be that calculated green depths for the pixels are unsuitable for bitmap display due to extreme differences in depths. These situations can be handled by converting Equation (1) to log form as follows:

depth of green=log(counts)(255)/log(maximum counts) (2)

The conversion may introduce errors, but luminance distribution will be more apparent. To enable the user to more easily judge luminance distribution, the luminance display bitmap 223 may include several horizontal lines which are at these luminance values 16, 46, 93, 140, 188 and 235 as exemplary thresholds. Since the x-axis is the direction of video width, it is a simple matter to obtain luminance distribution in the direction of video width. Each vertical line of display bitmap reflects luminance distribution in each vertical scan line of video frame. If there is jitter between consecutive frames, the green depth of some pixels or even the positions of green pixels may change on the next refresh of the luminance display bitmap 223, and these changes will be very apparent to the user, particularly with a black background bitmap. Conversely, if the user were only watching the video, these jitters might not be as apparent.

The video measure module 155 can provide an alarm to warn the user when diagnostic thresholds are surpassed. For example, if there are frame pixels whose luminance values are above some threshold, say 235, the threshold at luminance value 235 in FIG. 11 will change its color from green to red or some other color to instantly warn the user.

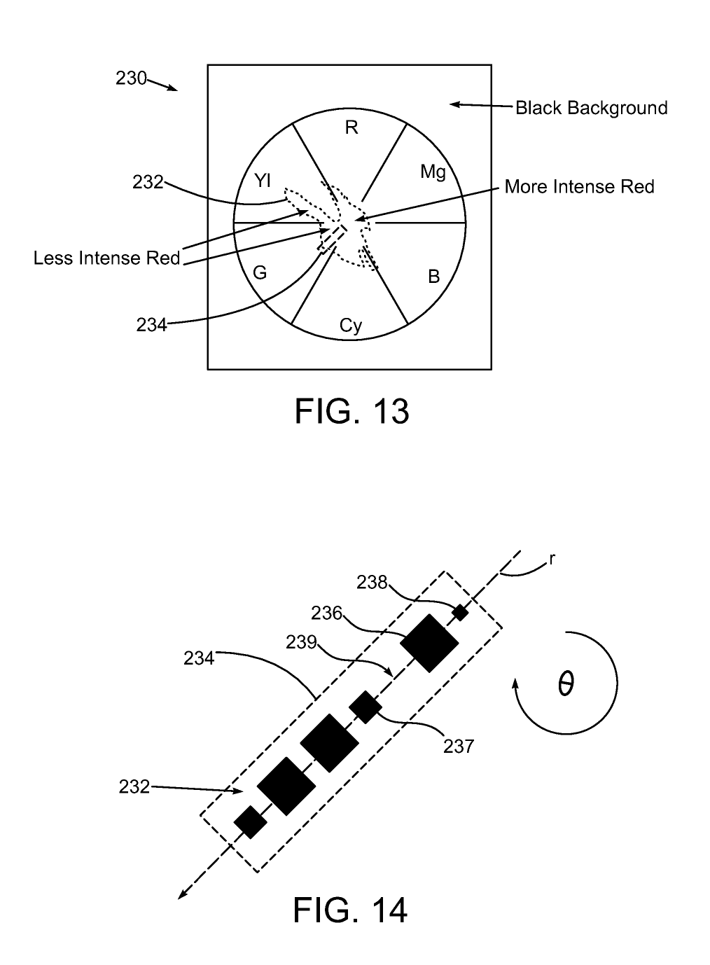

An exemplary final chrominance display bitmap 230 that may be presented to the user is depicted in FIG. 13. The chrominance display bitmap 230 may consist of an array 232 of red pixels with black background where the red pixels reflect chrominance distribution. The bitmap may be divided into color sectors R, Mg, B, Cy, G and Yl, where Mg, Cy and Yl stand for magenta, cyan and yellow, respectively. Since the chrominance statistic (Table 2) has the same size as the chrominance display bitmap 230, calculation of color intensity may be done without resampling. The intensity of red (i.e., more intense red or less intense red) for each pixel depends on the repeat number of its (U, V) value in the entire frame.

The scale of FIG. 13 is such that individual pixels of the array 232 are difficult to readily depict. However, and to aid understanding, the differing red depths or intensities can represented graphically in black and white in FIG. 14. Before turning to FIG. 14, note that the small dashed rectangle encompasses a portion 234 of the pixel array 232 in FIG. 14. The portion 234 of the pixel array 232 is shown schematically and at greater magnification in FIG. 14. The portion 234 includes a few red pixels whose position is given by some distance along a radius r at some angle θ relative to some arbitrary axis. FIG. 14 represents pixels from FIG. 11 with different red intensities graphically in the form of black squares of different sizes. The large black squares 236 represent pixels with high intensity red color, the medium size squares 237 represent pixels with medium intensity red, the small black squares 238 represent pixels with low intensity red and the blank(s) 239 represent pixels with zero intensity (which will typically be the background color, such as the black background in FIG. 11). Of course, there may be more or less size categories.

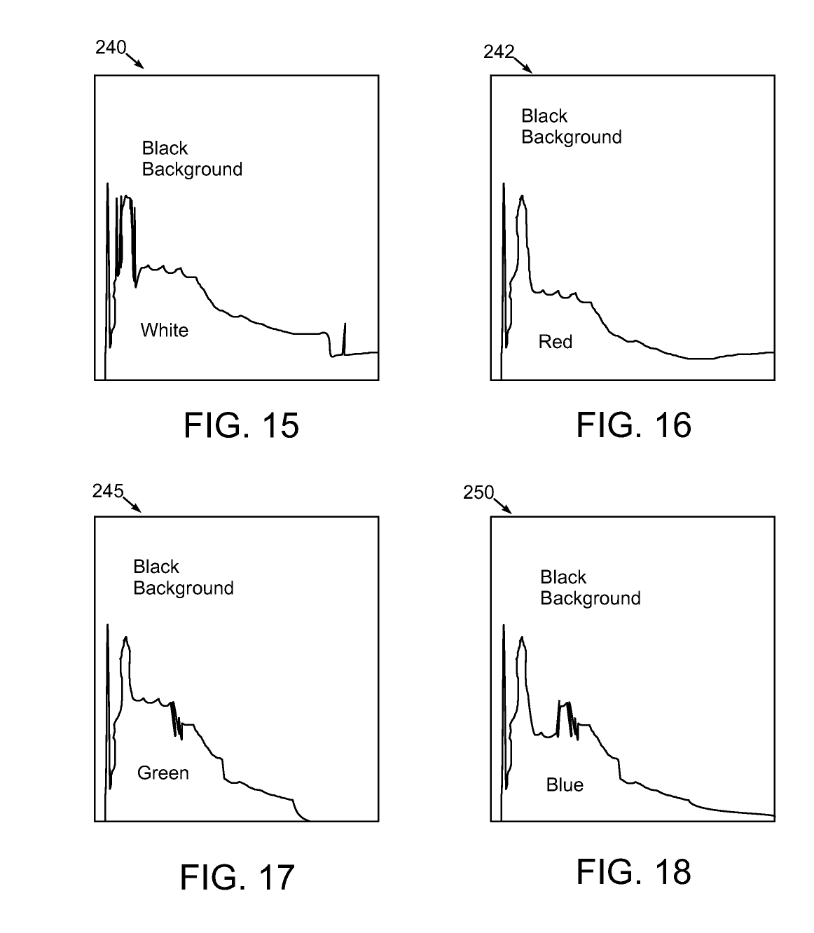

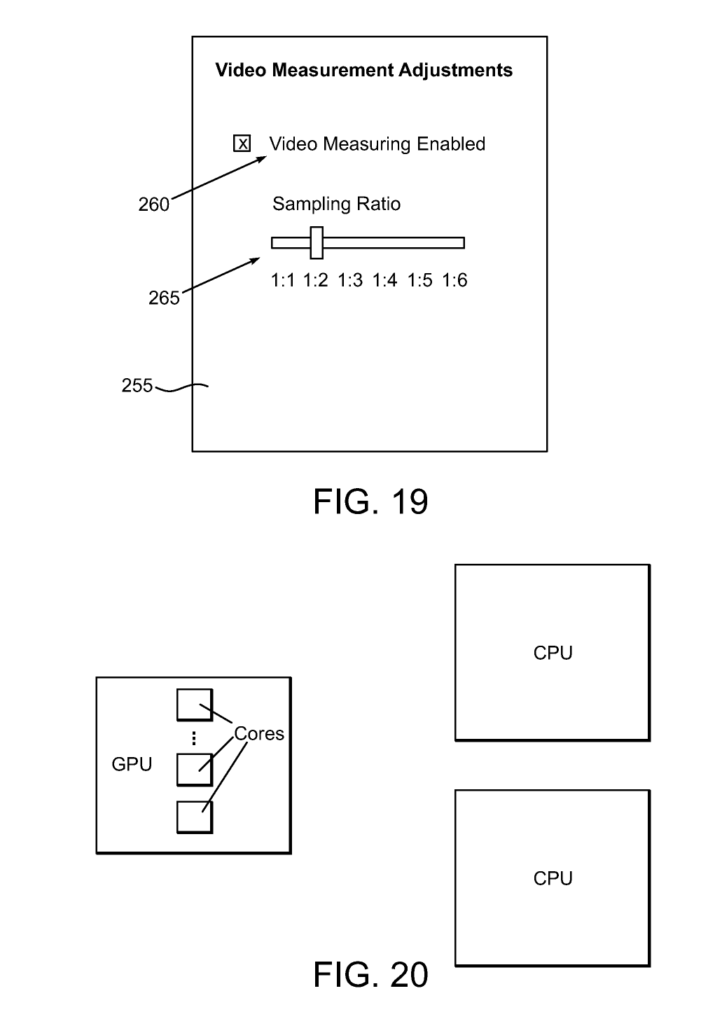

An exemplary final luminance histogram display bitmap 240 based on the data in Table 3 that may be presented to the user is schematically depicted in FIG. 15. The luminance histogram display bitmap 240 may consist of a white histogram with a black background. If one luminance value has the highest repeat number, its histogram will be higher than the others. The height for each luminance value is given by:

height of luminance value=(counts)(255)/maximum counts (3)

An exemplary final Red histogram display bitmap 242 based on the data in Table 4 that may be presented to the user is schematically depicted in FIG. 16. The Red histogram display bitmap 242 may consist of a Red histogram with a black background. If one Red color value has the highest repeat number, its histogram will be higher than the others. The height for each Red color value is given by:

height of red=(counts)(255)/(maximum counts) (4)

An exemplary final Green histogram display bitmap 245 based on the data in Table 5 that may be presented to the user is schematically depicted in FIG. 17. The Green histogram display bitmap 245 may consist of a Green histogram with a black background. If one Green color value has the highest repeat number, its histogram will be higher than the others. The height for each Green color value is given by:

height of green=(counts)(255)/(maximum counts) (5)

An exemplary final Blue histogram display bitmap 250 based on the data in Table 5 that may be presented to the user is schematically depicted in FIG. 18. The Blue histogram display bitmap 250 may consist of a Blue histogram with a black background. If one Blue color value has the highest repeat number, its histogram will be higher than the others. The height for each Blue color value is given by:

height of blue=(counts)(255)/(maximum counts) (6)

In an alternate exemplary embodiment, the luminance display bitmap 225 in FIG. 11 and the chrominance display bitmap 230 in FIG. 12 could be overlaid as a single display with a black background in circumstances where the luminance display width is natively or scaled to the same width as the chrominance data, say 256. Indeed, the Red, Green and Blue histograms 240, 245 and 250 of FIGS. 16, 17 and 18 can also be overlaid as a single display with white background, and even the luminance histogram 240 of FIG. 15 could be added in as well. Such overlays could be represented in a variety of ways, such as one or more variant of the property per pixel notations depicted in FIG. 12 and/or FIG. 14 above.

With the foregoing display bitmaps 223, 230, 240, 242, 245 and 250 in hand on either the computing system 10 or the computing system 20 or both, the user can make quick decisions about video quality, and if appropriate, make video settings locally or transmit the video settings from one computing system 20 to the other computing system 10 shown in FIG. 1. After generating foregoing six or less display bitmaps 223, 230, 240, 242, 245 and 250, the processor 35 (FIG. 2) sends these bitmaps to memory for immediate access thereto by the application 160 (FIGS. 6, 7 and 8), and can also send an event to the application 160. Upon receipt of the event, the application 160 will read the display bitmaps 223, 230, 240, 242, 245 and 250 data and display them immediately. Optionally, the blending stage 165 (FIGS. 7 and 8) can be called upon to display some or all of the display bitmaps 223, 230, 240, 242, 245 and 250 on top of the video frame directly without any time difference. These two methods can coexist. To conserve power consumed by the processor 35 (FIG. 2), the video measure module 155 may provide interface for the user to set sampling ratio or even turn off video measuring according to processor ability and measuring requirements. An exemplary user interface 255 is depicted in FIG. 17. While the interface 255 may take on a variety of configurations, this embodiment includes a check box 260 to enable/disable video measuring, and a slider 265 to enable the user to set the sampling ratio to different ratios, e.g., 1:1, 1:2, etc.

Referring again to FIGS. 2, 6, 7 and 8, the video measure module 155 may work for both software processed pipelines and hardware accelerated pipelines. For an exemplary software processed pipeline, all the calculations of decoding (stages 130, 135 and 140) and post processing (stage 145) can be executed on the processor 35. The video measure module 155 works with decoded frame data, which can be quite large and thus require numerous calculations. To save power for decoding and post processing, the video measure module 155 may skip some scan lines of some frames or even the entire frames. For a given processor 35, the higher the video resolution, the greater amounts of frame data the video measure module 155 will skip to yield smooth video playback. For protected video content, the video measure module 155 may skip more scan lines of frames and more entire frames, so no intelligible frame can be reconstructed from these display bitmaps after they are shared with an application 160 (see FIG. 6). Exemplary software implementations include a DirectShow Filter or Media Foundation Transform, both of which can be easily added into any video playback pipeline.

For an exemplary hardware accelerated pipeline, some operating system vendors, such as Microsoft, define the interfaces to decode and post process video frames, while graphics processing unit (GPU) manufacturers often implement these interfaces in their multimedia drivers. A typical multimedia driver with complete decoding and post processing for a frame and then send the frame data to display memory for final rendering. Thus, the video measure module 155 may be written into the multimedia driver.

Alternatively, a GPU can be very efficient for parallel calculation, and thus can be tasked to do most calculations of decoding and post processing without too much burden, so it will be possible to measure every entire frame in real time. An exemplary GPU with multiple Cores and two exemplary CPUs are depicted schematically in FIG. 20, although it should be understood that an APU could include both. According to the calculation ability of current popular GPUs, all the calculations of decoding, post processing and video measuring can be run on a GPU without impacting video playback. Modern processor architectures have embraced parallelism as an important pathway to increase performance. The GPU accelerates an application running on the CPU by offloading some of the compute-intensive and time consuming portion of the code. The rest of the application still runs on the CPU. The application runs faster because it is using the massively parallel processing power of the GPU to boost performance. Open Computing Language (OpenCL) is an open industry standard for general purpose parallel programming across CPUs, GPUs and other discrete computing devices organized into a single platform. OpenCL is a framework for parallel programming and includes a language, API, libraries and a runtime system to support software development. Using OpenCL, for example, a programmer can write general purpose programs that execute on GPUs without the need to map their algorithms onto a 3D graphics API such as OpenGL or DirectX.

Referring again to FIG. 8, the convert color space stage 170 involves calculation of color space conversion for frame data. These workloads are suitable for GPUs because all the calculations can be divided into hundreds of independent work-items, each work-item takes charge of several frame pixels, and these work-items are assigned to hundreds of GPU cores for execution. For example, if there are 500 work-items and 200 cores, 100 cores will execute twice while the remaining 100 cores will execute three times. For calculation of, for example, the luminance statistic (Table 1), calculations can be divided into hundreds of independent work-items, each work-item takes charge of several frame pixels, and these work-items are assigned to hundreds of GPU cores. When each work-item finishes its calculation, it will add up its statistic result on local memory associated with its work-group. Once all work-items of one work-group finish adding up their statistic results on local memory, one work-item of this work-group will add up this work-group's statistic result on global memory. After all work-groups finish adding up their statistic results on global memory, the global memory holds the statistic result of the entire frame. Accessing local memory is more efficient than accessing global memory, so most work-items of one work-group will access only local memory as a temporary buffer.

For calculation of a rescaled statistic (stage 180 in FIG. 8), all calculations can also be divided into hundreds of independent work-items and each work-item takes charge of several statistic values, and then these work-items are assigned to hundreds of GPU cores. This algorithm may consist of two parts. The first part yields the maximum value of the previous statistic result. It uses the similar algorithm as statistic, each work-item calculates to get its maximum value and then compares it with the value stored on local memory and places the larger one on local memory. After all work-items of one work-group finish these operations, this work-group holds its maximum value stored on local memory and then one work-item of this work-group will compare this work-group's maximum value with the value stored on global memory and put the larger one on global memory. After all work-groups finish these operations, the global memory holds the maximum value of the previous statistic result. The second part is as straightforward as converting color space and each work-item rescales several statistic values with that maximum statistic value.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system for displaying video, comprising:
a first computing system being operable to render video data from a multimedia source; and
a video measurement module associated with the first computing device and being operable to calculate from the video data at least one statistic representing at least one aspect of the video data and generate for display a visual depiction of at least one statistic to a user.

2. The system of claim 1, comprising a second computing system including a second display, the first computing system being operable to present the visual depiction of the at least one statistic on the second display of the second computing system.

3. The system of claim 2, wherein the second computing system is operable to send at least one control setting to the first computing system.

4. The system of claim 1, wherein the system comprises a processing pipeline including a video decode stage, a post process stage and video render stage and the video measurement module is operable to receive an input signal from the post process stage and render an output to an application, to the video render stage or to both.

5. The system of claim 4, wherein the video measurement module comprises software or hardware or both.

6. The system of claim 1, wherein the at least one aspect of the video data comprises luminance, chrominance and color data.

7. A method, comprising:
providing a first computing system including a first display and being operable to render video data from a multimedia source; and
calculating from the video data at least one statistic representing at least one aspect of the video data and presenting a visual depiction of at least one statistic to a user.

8. The method of claim 7, comprising providing a second computing system including a second display, and presenting the visual depiction of the at least one statistic on the second display of the second computing system.

9. The method of claim 8, sending at least one control setting from the second computing system to the first computing system.

10. The method of claim 7, wherein the first computing system comprises a processing pipeline including a video decode stage, a post process stage and video render stage, the method comprising receiving an input signal from the post process stage and rendering an output to an application, to the video render stage or to both.

11. The method of claim 7, wherein the at least one aspect of the video data comprises luminance, chrominance and color data.

12. In a system including a first computing system having a first display and being operable to render video data from a multimedia source, a method, comprising:
calculating from the video data at least one statistic representing at least one aspect of the video data; and
presenting a visual depiction of at least one statistic to a user.

13. The method of claim 12, comprising presenting the visual depiction of the at least one statistic on a second display of a second computing system.

14. The method of claim 13, sending at least one control setting from the second computing system to the first computing system.

15. The method of claim 12, wherein the first computer system comprises a processing pipeline including a video decode stage, a post process stage and video render stage, the method including receiving with a measurement module an input signal from the post process stage and rendering an output to an application, to the video render stage or to both.

16. The method of claim 15, wherein the video measurement module comprises software or hardware or both.

17. The method of claim 12, wherein the at least one aspect of the video data comprises luminance, chrominance and color data.

18. A computer readable medium having computer readable instructions for performing a method comprising:
rendering video data from a multimedia source;
calculating from the video data at least one statistic representing at least one aspect of the video data; and
presenting a visual depiction of at least one statistic to a user.

19. The computer readable medium of claim 18, comprising instructions to move data through a processing pipeline including a video decode stage, a post process stage and video render stage, the method including receiving with a measurement module an input signal from the post process stage and rendering an output to an application, to the video render stage or to both.

20. The computer readable medium of claim 18, wherein the at least one aspect of the video data comprises luminance, chrominance and color data.
